(19) United States
(12) Patent Application Publication
(10) Pub. No.: US 2024/0311127 A1
(43) Pub. Date: Sep. 19, 2024

(54) INFORMATION PROCESSING APPARATUS FOR VEHICLE, SOFTWARE UPDATE SYSTEM FOR VEHICLE, AND NON-TRANSITORY STORAGE MEDIUM

(71) Applicant: TOYOTA JIDOSHA KABUSHIKI KAISHA, Toyota-shi (JP)

(72) Inventors: Tomoaki MIYAZAWA, Nagoya-shi (JP); Ryota NAKABAYASHI, Nagoya-shi (JP); Naoki YOMODA, Toyota-shi (JP); Atsushi MORI, Miyoshi-shi (JP); Hiroshi INOUE, Nagoya-shi (JP); Tsukasa KITAZAWA, Toyota-shi (JP)

(73) Assignee: TOYOTA JIDOSHA KABUSHIKI KAISHA, Toyota-shi (JP)

(21) Appl. No.: 18/436,605

(22) Filed: Feb. 8, 2024

(30) Foreign Application Priority Data
Mar. 13, 2023 (JP) 2023-038710

(51) Int. Cl. G06F 8/65

(52) U.S. Cl. CPC G06F 8/65

(57) ABSTRACT

An information processing apparatus for a vehicle includes one or more processors configured to: set a permission period of an update process based on input from an outside, the update process being a process in which software of an electronic control unit mounted on the vehicle is updated to update software; when no permission period is set, execute the update process on condition that an approval signal indicating approval to the update process is acquired; and when the permission period is set, execute the update process in the permission period not on the condition that the approval signal is acquired.

### CROSS-REFERENCE TO RELATED APPLICATION

This application claims priority to Japanese Patent Application No. 2023-038710 filed on Mar. 13, 2023, incorporated herein by reference in its entirety.

### BACKGROUND

### 1. Technical Field

The disclosure relates to an information processing apparatus for a vehicle, a software update system for a vehicle, and a non-transitory storage medium.

### 2. Description of Related Art

A vehicle described in Japanese Unexamined Patent Application Publication No. 2021-105923 (JP 2021-105923 A) includes an electronic control unit and an information processing apparatus that manages software updates to the electronic control unit. The information processing apparatus executes an update process for updating software of the electronic control unit to update software. The update process includes downloading, by the information processing apparatus, the update software from a server, installing, by the information processing apparatus, the update software on the electronic control unit, and activating, by the information processing apparatus, the installed update software. The information processing apparatus obtains advance approval from a user of the vehicle previous to executing such an update process.

### SUMMARY

As described in JP 2021-105923 A, if approval of the user is obtained each time the software is updated to update software, the user is forced to handle a procedure each time, so the user can feel burdensome. On the other hand, if the software is updated to update software without obtaining approval of the user, the user is not able to use functions using the update software during the update process, so the user may be inconvenient. Therefore, depending on circumstances, the user him or herself can want to control time for an update.

A first aspect of the disclosure provides an information processing apparatus for a vehicle. The information processing apparatus includes one or more processors configured to: set a permission period of an update process based on input from an outside, wherein the update process is a process in which software of an electronic control unit mounted on the vehicle is updated to update software; when no permission period is set, execute the update process on condition that an approval signal indicating approval to the update process is acquired; and, when the permission period is set, execute the update process in the permission period not on the condition that the approval signal is acquired.

A second aspect of the disclosure provides a software update system for a vehicle. The software update system includes: an electronic control unit mounted on the vehicle; an information processing apparatus configured to manage an update of software of the electronic control unit; and an input device configured to receive input from a user. The information processing apparatus is configured to set a permission period of an update process based on input through the input device, wherein the update process is a process in which software of the electronic control unit is updated to update software, when no permission period is set, execute the update process on condition that an approval signal indicating approval to the update process is acquired from the input device, and, when the permission period is set, execute the update process in the permission period not on the condition that the approval signal is acquired.

A third aspect of the disclosure provides a non-transitory storage medium storing instructions executable on an information processing apparatus and causing the information processing apparatus to execute functions. The information processing apparatus is mounted on a vehicle together with an electronic control unit. The information processing apparatus is configured to manage software of the electronic control unit. The functions include: setting a permission period of an update process based on input from an outside, wherein the update process is a process in which the software of the electronic control unit is updated to update software; when no permission period is set, executing the update process on condition that an approval signal indicating approval to the update process is acquired; and when the permission period is set, executing the update process in the permission period not on the condition that the approval signal is acquired.

With the above-described technical ideas, in updating software, it is possible to reduce burden on a user involved in approval of an update and suppress a thoughtless update.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle;

FIG. 2 is a flowchart that shows the procedure of a setting process;

FIG. 3 is a view that shows an example of a setting image;

FIG. 4 is a flowchart that shows the procedure of a first process;

FIG. 5 is a flowchart that shows the procedure of a second process;

FIG. 6 is a flowchart that shows a modification of the first process;

FIG. 7 is a flowchart that shows a modification of the second process;

FIG. 8 is a flowchart that shows a modification of the first process; and

FIG. 9 is a flowchart that shows a modification of the second process.

### DETAILED DESCRIPTION OF EMBODIMENTS

Hereinafter, an embodiment of a software update system for a vehicle, including an information processing apparatus for a vehicle, will be described with reference to the drawings. In the present embodiment, a case where the software update system for a vehicle is applied to a battery electric vehicle is taken as an example.

### Overall Configuration of Vehicle

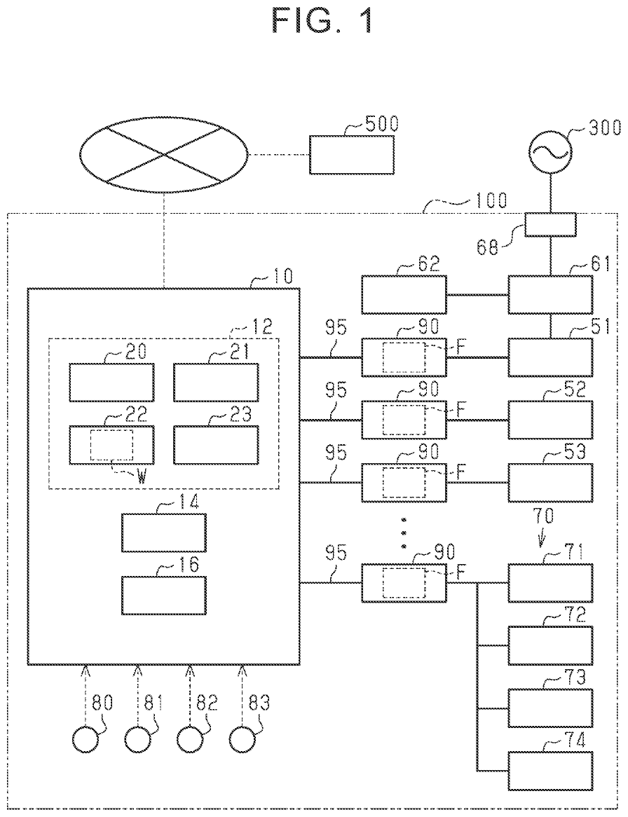

As shown in FIG. 1, a vehicle 100 includes an OTA master 10. The OTA master 10 includes a processing circuit 12. The processing circuit 12 includes a CPU 20, a first memory 21, a second memory 22, and a third memory 23. The first memory 21 is a nonvolatile storage medium. The first memory 21 is electrically rewritable. The first memory 21, for example, functions as a storage that stores data received from an outside. The second memory 22 is a nonvolatile storage medium. The second memory 22 is electrically rewritable. The second memory 22 stores software. The software is a collection of various programs W and various data. The various programs W describe processes to be executed by the CPU 20. The various data will be needed when the CPU 20 runs the programs W. The third memory 23 is a volatile storage medium. The OTA master 10 includes a communication module 14. The communication module 14 is a communication circuit for wireless communication with an outside via an external communication line network. The OTA master 10 includes a real-time clock 16. The real-time clock 16 is a circuit that generates information on date and time. The OTA master 10 is an information processing apparatus mounted on the vehicle 100. The OTA master 10 is also an electronic control unit mounted on the vehicle 100.

The vehicle 100 includes a plurality of specific controllers 90 and a plurality of in-vehicle apparatuses. FIG. 1 representatively shows four of the specific controllers 90. One of the plurality of in-vehicle apparatuses is a motor apparatus 51 that serves as a driving source of the vehicle 100. The motor apparatus 51 includes a motor generator and an inverter that converts electric power between direct-current power and alternating-current power. One of the plurality of in-vehicle apparatuses is a hydraulic brake device 52. One of the plurality of in-vehicle apparatuses is an electric parking brake device 53. Other than those, the in-vehicle apparatuses include an air-conditioning apparatus, a turn signal indicator, a plurality of HMI apparatuses 70, and the like. The HMI apparatuses 70 are, for example, apparatuses for exchanging information with a user by using light or sound. Each of the specific controllers 90 is an electronic control unit configured to control a specific one of the plurality of in-vehicle apparatuses. Therefore, an example of the specific controller 90 is a motor ECU. An individual identification value is assigned in advance to each specific controller 90. Each specific controller 90 is capable of communicating with the OTA master 10 via a bus 95. Hereinafter, the specific controller 90 configured to control the motor apparatus 51, the specific controller 90 configured to control the hydraulic brake device 52, and the specific controller 90 configured to control the parking brake device 53 are collectively referred to as driving system specific controllers 90.

Each specific controller 90 includes a processing circuit similar to that of the OTA master 10. In other words, the specific controller 90 includes a CPU, a nonvolatile first memory, a nonvolatile second memory, and a volatile third memory. The second memory stores software F for controlling the intended in-vehicle apparatus. In the specific controllers 90 and the OTA master 10, the nonvolatile memories adopted in the present embodiment each have a double-bank structure. A memory having a double-bank structure of this type has two storage areas. When data in one of the storage areas is being read, writing to the other one of the storage areas is allowed to be performed.

### HMI Apparatuses

One of the HMI apparatuses 70 is a display 71. One of the HMI apparatuses 70 is a voice recognition apparatus 72. One of the HMI apparatuses 70 is a speaker 73. One of the HMI apparatuses 70 is a push switch 74. The push switch 74 is used to, for example, replay, stop, and adjust the sound level of music and moving images. The above-described HMI apparatuses 70 are examples, and the HMI apparatuses 70 include other apparatuses. The display 71, the voice recognition apparatus 72, the speaker 73, and the push switch 74 are located in the cabin of the vehicle 100. In the present embodiment, the display 71, the voice recognition apparatus 72, the speaker 73, and the push switch 74 are controlled by the HMI controller that is the same specific controller 90.

The display 71 includes a display screen and a drive circuit. The display 71 displays an image according to an instruction signal sent from the HMI controller on a display screen. The display 71 is of a touch panel type. In other words, when the user performs input operation on the display screen of the display 71, the display 71 sends a signal corresponding to the input operation to the HMI controller. The HMI controller may send an instruction signal to the display 71 under instructions sent from the OTA master 10. The HMI controller, where necessary, sends a signal from the display 71 to the OTA master 10. The display 71 is an input device that receives input from the user. The display 71 according to the present embodiment is a center display located between a driver seat and a front passenger seat.

The voice recognition apparatus 72 includes a microphone and a conversion circuit. The microphone collects sound in the vehicle cabin. The conversion circuit converts sound collected by the microphone to language data. The conversion circuit outputs the converted language data to the HMI controller. The HMI controller, where necessary, sends language data received from the voice recognition apparatus 72 to the OTA master 10. The voice recognition apparatus 72 is an input device that receives input from the user.

The speaker 73 emits a sound according to an instruction signal sent from the HMI controller. The HMI controller may send an instruction signal to the speaker 73 under instructions sent from the OTA master 10.

Here, as described above, the HMI controller may send an instruction signal to the display 71 under instructions from the OTA master 10. In terms of this point, hereinafter, the description of a point that the HMI controller is disposed between the OTA master 10 and the display 71 is omitted. For example, it may be described that the OTA master 10 sends an instruction signal to the display 71 or the OTA master 10 causes the display 71 to display an image. Similarly, hereinafter, the description of a point that the HMI controller is disposed midway when a signal from the display 71 is sent from the HMI controller to the OTA master 10 is omitted. This also applies to the voice recognition apparatus 72 and the speaker 73.

### Other Configuration

The vehicle 100 includes a first battery 61. The first battery 61 is a high-voltage battery for driving the vehicle 100. The first battery 61 is a secondary battery that exchanges electric power with the motor apparatus 51.

The vehicle 100 includes a connector 68. The connector 68 is connected to the first battery 61 via a power line. An external power supply 300 for the vehicle 100 is connectable to the connector 68. The first battery 61 is rechargeable with electric power supplied from the external power supply 300 via the connector 68. Hereinafter, charging the first battery 61 by using the external power supply 300 is simply referred to as charging the first battery 61.

The vehicle 100 includes a second battery 62. The second battery 62 is a low-voltage battery having a lower rated voltage than the first battery 61. The second battery 62 is a secondary battery. The second battery 62 is connected to the first battery 61 via a step-down converter (not shown). The second battery 62, for example, supplies electric power to the OTA master 10, the specific controllers 90, and various auxiliaries. Here, the auxiliaries include the HMI apparatuses 70, switches, sensors, and the like.

The vehicle 100 includes a battery sensor 81, a charge sensor 82, and a vehicle speed sensor 83. The battery sensor 81 detects battery information, that is, the temperature, voltage, and current of the first battery 61. The charge sensor 82 detects a charging current. The charging current is a current flowing through the power line that connects the first battery 61 to the connector 68. The vehicle speed sensor 83 detects the travel speed of the vehicle 100.

The vehicle 100 includes a start switch 80. The start switch 80 may be referred to as system startup switch. The start switch 80 is a switch for allowing the user to instruct the vehicle 100 to start up. When the start switch 80 is operated to turn on or off by the user, the system of the vehicle 100 turns on or off. A state where the system of the vehicle 100 is on includes a state where the vehicle 100 is ready to run and a so-called accessory on state. The state where the vehicle 100 is ready to run is a state where the first battery 61 is supplying electric power to the motor apparatus 51 and the second battery 62 is supplying electric power to the specific controllers 90. Each of the specific controllers 90 is in a startup state when being supplied with electric power. The accessory on state is a state where the first battery 61 is not supplying electric power to the motor apparatus 51 while the second battery 62 is supplying electric power to the specific controllers 90. In other words, the accessory on state is a state where the vehicle 100 is not ready to run but some in-vehicle components are usable. When, for example, the start switch 80 is operated to an on state in a state where a brake pedal of the vehicle 100 is depressed, the vehicle 100 enters the ready-to-run state. On the other hand, when the start switch 80 is operated to the on state in a state where the brake pedal of the vehicle 100 is not depressed, the vehicle 100 enters the accessory on state. The state where the system of the vehicle 100 is off is a state where the first battery 61 is not supplying electric power to the motor apparatus 51 and the second battery 62 is not supplying electric power to the specific controllers 90. Here, the OTA master 10 maintains a startup state by receiving electric power supplied from the second battery 62 even when the system of the vehicle 100 is on or off. This also applies to the battery sensor 81 and the charge sensor 82. Even when the system of the vehicle 100 is off, each of the specific controllers 90 temporarily enters the startup state by receiving electric power supplied from the second battery 62 where necessary. This also applies to the display 71. The OTA master 10 receives a signal indicating the state of the vehicle 100 according to on-off operation of the start switch 80. Accordingly, the OTA master 10 can hold whether the system of the vehicle 100 is on or off and also whether the vehicle 100 is in the ready-to-run state or in the accessory on state.

The in-vehicle components including the above-described OTA master 10, specific controllers 90, HMI apparatuses 70, sensors, start switch 80, and batteries make up the software update system for a vehicle.

### OTA Server

An OTA server 500 is a management server provided outside the vehicle 100. The OTA server 500 manages information on software of a plurality of vehicles registered in advance. The OTA server 500 stores pieces of latest update software respectively applicable to the vehicles according to segments, such as vehicle type and model. When new update software is registered, the OTA server 500 launches a campaign for the update software. In other words, upon a request from a vehicle, the OTA server 500 distributes new update software to the vehicle to be applied.

### Outline of Functions of OTA Master

The CPU 20 of the OTA master 10 runs the programs W stored in the second memory 22 to execute the following operations. In other words, the CPU 20 implements various processes for managing updates of software in the specific controllers 90. Hereinafter, the various processes will be described.

The CPU 20 is capable of executing three-type update processes. The update processes are processes for updating software in the specific controller 90 to update software. One of the three-type update processes is a download process. The download process is to receive update software from the OTA server 500 by using wireless communication and store the received update software in the first memory 21. Another one of the three-type update processes is an installing process. The installing process is to store the update software, obtained in the download process, in the second memory of the intended specific controller 90. The other one of the three-type update processes is an activation process. The activation process is to activate the update software stored in the specific controller 90 through the installing process. Activation is to change the setting of the specific controller 90 such that the specific controller 90 executes a process by referring to the update software. For example, the CPU 20 changes the setting of a read flag in the specific controller 90 in the activation process. The read flag is a flag for, when the specific controller 90 reads software, designating the intended storage area. When the setting of the read flag is changed, the storage area from which software is read switches from the storage area in which the software at a current point in time is stored to the storage area in which the update software is stored in the specific controller 90. A technology to update software by using wireless communication may be referred to as Over The Air (OTA).

Hereinafter, when the download process, the installing process, and the activation process are collectively referred and described, these processes are referred to as update process, and, when these processes are separately described, these processes are referred to as individual process names.

The CPU 20 is capable of executing a setting process. In the setting process, the CPU 20 sets a permission period of the update process based on input from the user through the display 71. Here, approval of the user is needed to update software to update software. The permission period is a period in which the following operation is approved by the user in advance. The operation is to execute the update process. Therefore, the CPU 20 is allowed to execute the update process without obtaining approval of the user at that point in time in the permission period. In the setting process, the CPU 20 stores the permission period provided by instructions from the user in the first memory 21 or erases the temporarily stored permission period from the first memory 21 in response to input from the user. When the user provides instructions to set a permission period, the CPU 20 sets a permission flag to an on state. On the other hand, when the user provides instructions not to set a permission period, the CPU 20 sets the permission flag to an off state.

The CPU 20 is capable of executing two-type executable processes for executing the update process. A first process that is one of the executable processes is basically dedicated to when the system of the vehicle 100 is off. However, part of the first process reaches a period during which the system of the vehicle 100 is on. A second process that is the other one of the executable processes is basically dedicated to when the system of the vehicle 100 is on. However, part of the second process reaches a period during which the system of the vehicle 100 is off.

Each of the executable processes is characterized as follows. In the executable process, when no permission period is set, the CPU 20 executes the update process on condition that an approval signal is acquired from the display 71 or the voice recognition apparatus 72. The approval signal is a signal indicating approval to execute the update process. On the other hand, when the permission period is set, the CPU 20 executes the update process in the permission period not on condition that the approval signal is acquired. The CPU 20 basically executes the update process in these two cases and also executes the update process in the following cases. When, for example, the travel speed of the vehicle 100 is higher than zero, that is, the vehicle 100 is running, the CPU 20 executes the update process on condition that the approval signal is acquired regardless of whether the permission period is set. In addition, for the driving system specific controllers 90, the CPU 20 executes the update process on condition that the approval signal is acquired regardless of whether the permission period is set. On the other hand, when the first battery 61 is being charged, the CPU 20 executes the update process not on condition that the approval signal is acquired regardless of whether the permission period is set. Strictly speaking, whether the approval signal needs to be acquired depends on a combination of the type of the specific controller 90 and the level of charge and the like of the first battery 61. In terms of this point, the description will be made in detail later with reference to the flowcharts. The type of the specific controller 90 is the segment of the specific controller 90 according to an in-vehicle apparatus that the specific controller 90 is configured to control, for example, the above-described driving system. In the following description, receiving, by the OTA master 10, the approval signal from the display 71 or the voice recognition apparatus 72 corresponds to acquiring, by the OTA master 10, the approval signal from the display 71 or the voice recognition apparatus 72.

The CPU 20 repeatedly calculates the state of charge of the first battery 61 on the precondition that the CPU 20 executes the first process and the second process. The state of charge of the first battery 61 is the ratio of the level of the first battery 61 to the full charge capacity of the first battery 61. The CPU 20 is capable of calculating the state of charge of the first battery 61 based on battery information detected by the battery sensor 81.

### Setting Process

Specific contents of the setting process will be described. In a state where the system of the vehicle 100 is on, when the user operates the display 71 to call a software update setting function, the CPU 20 starts the setting process.

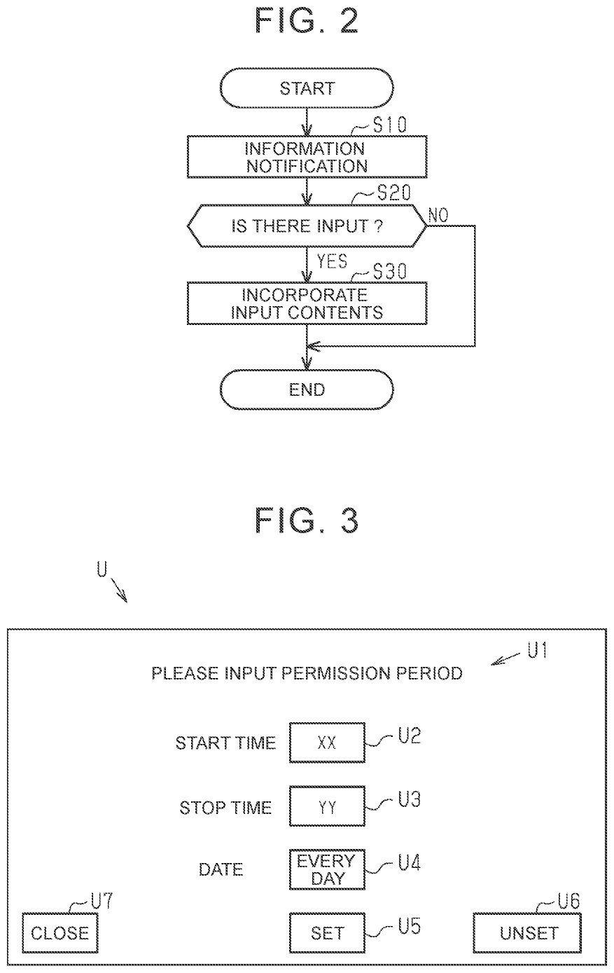

As shown in FIG. 2, when the CPU 20 starts the setting process, the CPU 20 initially executes the process of step S10. In step S10, the CPU 20 provides an information notification for setting a permission period. Specifically, the CPU 20 sends, to the display 71, an instruction signal for showing a setting image U shown in FIG. 3. In response to the instruction signal, the display 71 shows the setting image U. The setting image U contains the following display contents. The first display content is a message U1 prompting for input of the permission period. The second display content is a start input field U2 for allowing the user to input start time of the permission period. Text indicating that the input field U2 is intended for start time is present next to the input field U2. Hereinafter, one-by-one description is omitted, and all the input fields and buttons contained in the setting image U are allowed to receive operation of the user. The user is able to designate the start time of the permission period by performing operation to the start input field U2. In the present embodiment, time ranging from one o'clock to 24 o'clock, obtained by dividing one day into 24 hours by the hour, is allowed to be designated. The third display content is a stop input field U3 for allowing the user to input stop time of the permission period. Text indicating that the input field U3 is intended for stop time is present next to the input field U3. The user is able to designate the stop time of the permission period by performing operating to the input field U3. The user is able to designate the stop time by the hour as in the case of the start time. The fourth display content is a date input field U4 for allowing the user to input the date of the permission period. Text indicating that the input field U4 is intended for date is present next to the input field U4. The user is able to designate the date of the permission period by performing operation to the input field U4. In the present embodiment, the following three choices are allowed to be designated. The three choices include “every day”, “specific day of week”, and “specific date”. The fifth display content is a set button U5. The set button U5 is a button for the user to provide instructions to set the setting contents on the permission period. The sixth display content is an unset button U6. The unset button U6 is a button for the user to provide instructions not to set the permission period. The seventh display content is a close button U7. The close button U7 is a button for the user to provide instructions to close the setting image U. Although not shown in the drawing, the setting image U contains the following display content. The display content is a message as follows. In other words, the message states that, even when the permission period is set, approval of the user is sought in executing a software update depending on, for example, the type of the specific controller 90 to be updated, and the state of the vehicle 100. As shown in FIG. 2, when the CPU 20 causes the display 71 to show the setting image U in step S10, the CPU 20 advances the process to step S20.

In step S20, the CPU 20 determines whether operation relevant to the permission period is input to the setting image U. When the set button U5 or the unset button U6 is operated before a predetermined period of time elapses from when the process proceeds to step S20, the CPU 20 determines that operation relevant to the permission period is input (YES in step S20). In this case, the CPU 20 advances the process to step S30. The CPU 20 advances the process to step S30 at a point in time when the set button U5 or the unset button U6 is operated. The predetermined period of time is determined in advance as, for example, a specified period of time within one minute. The predetermined period of time is, for example, 30 seconds.

In step S30, the CPU 20 stores the setting of the permission period designated by the user in the first memory 21. Specifically, the CPU 20 executes the following process. Initially, the CPU 20 resets information on the permission period, stored in the first memory 21 at a current point in time. In other words, when the permission flag is on at the current point in time, the CPU 20 switches the permission flag to the off state and erases the permission period stored in the first memory 21. On the other hand, when the permission flag is off at the current point in time, the CPU 20 does not execute anything. Subsequently, the CPU 20 incorporates the input contents of the setting image U into contents stored in the first memory 21. Specifically, when the set button U5 is operated, the CPU 20 sets the permission flag to the on state. At the same time, the CPU 20 causes the first memory 21 to store information on the start time, stop time, and date of the permission period input to the setting image U. On the other hand, when the unset button U6 is operated, the CPU 20 keeps the permission flag off. When the CPU 20 incorporates the input contents of the user into contents stored in the first memory 21, the CPU 20 causes the display 71 to close the setting image U. At the same time, the CPU 20 ends the process of step S30. Then, the CPU 20 ends the setting process.

On the other hand, in step S20, the CPU 20 determines that no operation relevant to the permission period is input, in any one of the following cases. The first case is a case where neither the set button U5 nor the unset button U6 is operated before the predetermined period of time elapses from when the process proceeds to step S20. The second case is a case where the close button U7 is operated before the predetermined period of time elapses from when the process proceeds to step S20. In any one of these cases (NO in step S20), the CPU 20 causes the display 71 to close the setting image U. Then, the CPU 20 ends the setting process. In the first case, the CPU 20 ends the setting process at a point in time when the predetermined period of time has elapsed. In the second case, the CPU 20 ends the setting process at a point in time when the close button U7 is operated. When the determination of step S20 is negative, the first memory 21 keeps holding thereafter existing information on the permission period stored at that point in time.

### First Process

When the system of the vehicle 100 is off, the CPU 20 starts the first process at predetermined execution time. The execution time is time ranging from one o'clock to 24 o'clock, obtained by dividing one day into 24 hours by the hour. In other words, the CPU 20 starts the first process every hour, for example, “one o'clock” or “two o'clock”, on the precondition that the system of the vehicle 100 is off.

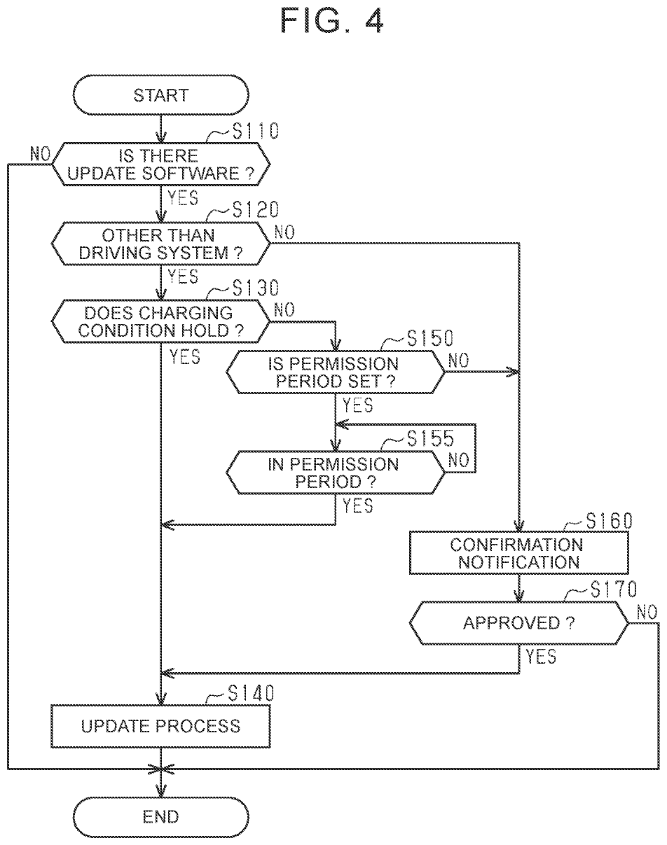

As shown in FIG. 4, when the CPU 20 starts the first process, the CPU 20 initially executes the process of step S110. In step S110, the CPU 20 determines whether there is new update software applicable to the vehicle 100. Specifically, initially, the CPU 20 sends a request to the OTA server 500 by using wireless communication to check for new update software. In response to this request, when the CPU 20 receives, from the OTA server 500, a notification that there is no new update software (NO in step S110), the CPU 20 ends the first process. On the other hand, when the CPU 20 receives, from the OTA server 500, a notification that there is new update software (YES in step S110), the CPU 20 advances the process to step S120. When the CPU 20 receives, from the OTA server 500, a notification that there is new update software, the CPU 20 receives software information together with the notification. The software information includes an identification value of the specific controller 90 to be updated, information on the data volume of the update software, and the like. The CPU 20 causes the first memory 21 to store the software information. In the example of the present embodiment, the OTA server 500 distributes the update software intended for one specific controller 90 in a specific campaign. In other words, the number of the specific controllers 90 to be updated in a single first process or in a single second process is one.

In step S120, the CPU 20 determines whether the specific controller 90 to be currently updated is other than the driving system specific controllers 90. The CPU 20 performs the determination by referring to a controlled item list stored in the second memory 22, and the software information received from the OTA server 500 in step S110. The controlled item list is a list that associates the identification value of each specific controller 90 with an in-vehicle apparatus that the specific controller 90 is configured to control. When the specific controller 90 to be updated is one of the driving system specific controllers 90 (NO in step S120), the CPU 20 advances the process to step S160.

In step S160, the CPU 20 provides a confirmation notification by display. Specifically, the CPU 20 initially waits until the system of the vehicle 100 switches from the off state to the on state. When the system of the vehicle 100 switches to the on state, the CPU 20 sends, to the display 71, an instruction signal for showing an approval image. Then, the display 71 shows the approval image. The approval image contains a message asking the user whether to execute the update process, an approve button, and a refuse button. The approve button is a button for the user approving execution of the update process. The refuse button is a button for the user refusing execution of the update process. The approve button and the refuse button are allowed to receive input operation from the user. The display 71 is set so as to function as follows in response to operation of the user to the approval image. In other words, when the user operates the approve button, the display 71 sends, to the OTA master 10, a first approval signal indicating approval to execution of the update process. When the user operates the refuse button, the display 71 sends, to the OTA master 10, a first refusal signal indicating refusal of execution of the update process. The first approval signal and the first refusal signal are predetermined as signals different from each other. When the CPU 20 causes the display 71 to show the approval image, the CPU 20 advances the process to step S170.

In step S170, the CPU 20 determines whether the user has approved execution of the update process. As a specific process of step S170, when the CPU 20 receives the first approval signal before a predetermined first standby time elapses from a point in time when the process proceeds to step S170, the CPU 20 determines that the user has approved execution of the update process (YES in step S170). In this case, the CPU 20 advances the process to step S140 at a point in time when the CPU 20 receives the first approval signal. The contents of the process of step S140 will be described later. The first standby time is, for example, 30 seconds as in the case of, for example, the above-described predetermined period of time.

On the other hand, when the CPU 20 does not receive the first approval signal before the first standby time elapses from a point in time when the process proceeds to step S170 in step S170, the CPU 20 determines that the user has not approved execution of the update process (NO in step S170). In this case, the CPU 20 ends the first process. The determination of step S170 is negative in any one of the following cases. The first case is a case where neither the first approval signal nor the first refusal signal is received before the first standby time elapses from when the process proceeds to step S170. The second case is a case where the first refusal signal is received before the first standby time elapses from when the process proceeds to step S170. In the first case, the CPU 20 ends the first process at a point in time when the first standby time has elapsed. In the second case, the CPU 20 ends the first process at a point in time when the first refusal signal is received. When the first process ends through step S170, the system of the vehicle 100 is on. Therefore, in this case, the CPU 20 does not execute the first process until the system of the vehicle 100 enters the off state again.

When the specific controller 90 to be updated is other than the driving system specific controllers 90 in step S120 (YES in step S120), the CPU 20 advances the process to step S130.

In step S130, the CPU 20 determines whether a charging condition holds. The charging condition is that both the following two requirements are satisfied. The first requirement is that the first battery 61 is being charged. The second requirement is that the state of charge of the first battery 61 at a current point in time is lower than or equal to a first state of charge. The first state of charge is predetermined as a value at which a certain long period of time, for example, an hour, is required to charge the first battery 61 from the first state of charge to a maximum state of charge. Therefore, when the second requirement is satisfied, it is estimated that charging of the first battery 61 continues over a certain long period of time thereafter. The CPU 20 determines whether the first requirement is satisfied as follows. In other words, the CPU 20 reads a latest charging current detected by the charge sensor 82. Then, when the charging current is greater than zero, the CPU 20 determines that the first requirement is satisfied. On the other hand, when the charging current is zero, the CPU 20 determines that the first requirement is not satisfied. The CPU 20 determines whether the second requirement is satisfied as follows. In other words, the CPU 20 reads the latest state of charge of the first battery 61, calculated from battery information. Then, when the latest state of charge is lower than or equal to the first state of charge, the CPU 20 determines that the second requirement is satisfied. On the other hand, when the latest state of charge is higher than the first state of charge, the CPU 20 determines that the second requirement is not satisfied. After the CPU 20 performs these determinations, when the charging condition holds (YES in step S130), the CPU 20 skips step S150 that will be described below and advances the process to step S140. On the other hand, when the charging condition does not hold (NO in step S130), the CPU 20 advances the process to step S150.

In step S150, the CPU 20 determines whether the permission period is set. At this time, the CPU 20 reads the permission flag stored in the first memory 21. When no permission period is set (NO in step S150), the CPU 20 advances the process to step S160 already described. On the other hand, when the permission period is set (YES in step S150), the CPU 20 advances the process to step S155.

In step S155, the CPU 20 determines whether the date and time at the current point in time is in the permission period, by consulting information on the permission period stored in the first memory 21. When the date and time at the current point in time is outside the permission period (NO in step S155), the CPU 20 executes the process of step S155 again. In other words, the CPU 20 repeatedly performs determination of step S155 and waits until the date and time at the current point in time is in the permission period. On the other hand, when the date and time at the current point in time is in the permission period (YES in step S155), the CPU 20 advances the process to step S140. When the system of the vehicle 100 switches from the off state to the on state while the CPU 20 is repeatedly performing the determination of step S155, the CPU 20 ends the first process at that point in time.

In step S140, the CPU 20 executes the update process to update the specific controller 90 to be updated with the update software. Initially, the CPU 20 executes the download process. Specifically, the CPU 20 makes a request of the OTA server 500 to send the update software. When the CPU 20 receives the update software from the OTA server 500 in response to this request, the CPU 20 causes the first memory 21 to store the received update software. After that, the CPU 20 executes the installing process. Specifically, the CPU 20 sends the intended update software and an instruction signal for storing the update software to the specific controller 90 to be updated. In response to this instruction signal, the specific controller 90 to be updated stores the update software in its own second memory. When the CPU 20 completes the installing process, the CPU 20 executes the activation process. Specifically, in the activation process, the CPU 20 sends an instruction signal for activating the update software stored in the installing process to the specific controller 90 to be updated. In response to this instruction signal, the specific controller 90 to be updated executes a process of activating the update software. The contents of activation have been already described above. When the CPU 20 completes the activation process, the CPU 20 erases the software information stored in the first memory 21. Then, the CPU 20 ends the process of step S140. At the same time, the CPU 20 ends the first process. The same applies to the second process (described later) in terms of erasing software information when the activation process is complete.

Here, in relation to the process of step S140, when the process proceeds from step S170 to step S140, the system of the vehicle 100 is on at that point in time. In this case, the CPU 20 executes the download process and the installing process while the system of the vehicle 100 is on. After that, the CPU 20 waits until the system of the vehicle 100 switches from the on state to the off state. Then, the CPU 20 executes the activation process when the system of the vehicle 100 switches to the off state. A series of the processes until the activation process completes is the process of step S140. On the other hand, in relation to the process of step S140, when the process proceeds from step S130 to step S140 or when the process proceeds from step S155 to step S140, the system of the vehicle 100 is off at that point in time. In this case, the CPU 20 completes all the download process, installing process, and activation process while the system of the vehicle 100 is off. If the user operates the start switch 80 to the on state to switch the system of the vehicle 100 from the off state to the on state in the middle of execution of the process of step S140, the CPU 20 causes the display 71 to show the following message. The message states that software update is being executed, and the system of the vehicle 100 is not allowed to be set to the on state. When the CPU 20 causes the display 71 to show this message, switching of the system of the vehicle 100 from the off state to the on state is placed on hold.

As for the above-described first process, in relation to the process of step S140, the process of step S160, or the like, time to execute a new first process can come in the middle of execution of the first process. In this case, the CPU 20 cancels execution of the first process at that time. Similarly, when time to execute the second process (described later) has come in the middle of execution of the first process, the CPU 20 cancels execution of the second process at that time.

### Second Process

When the system of the vehicle 100 is on, the CPU 20 starts the second process at predetermined execution time. The execution time is the same as that described in the first process. As described above, the CPU 20 may cancel execution of the second process in relation to the first process.

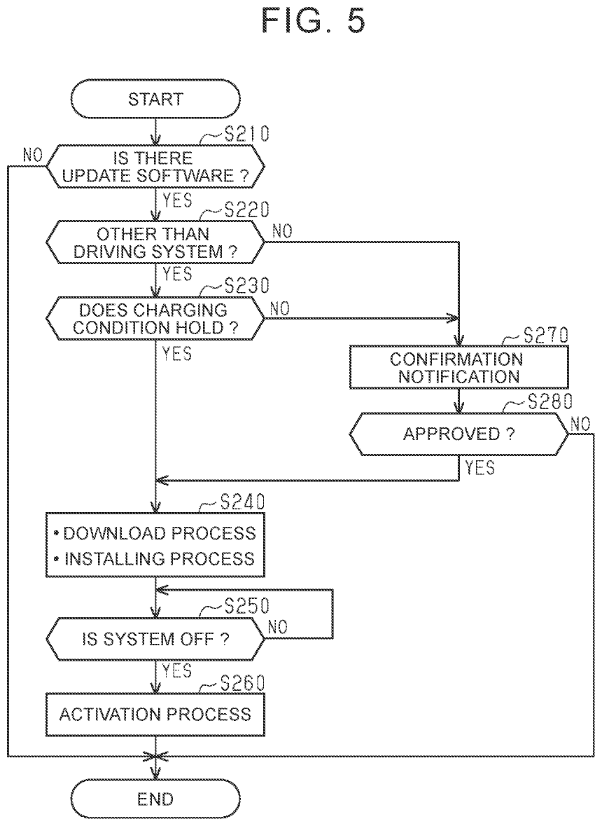

As shown in FIG. 5, when the CPU 20 starts the second process, the CPU 20 initially executes the process of step S210. In step S210, the CPU 20 determines whether there is new update software. The contents of the process of step S210 are the same as the contents of the process of step S110. Therefore, the detailed contents of the process of step S210 are omitted. When there is no new update software (NO in step S210), the CPU 20 ends the second process. On the other hand, when there is new update software (YES in step S210), the CPU 20 advances the process to step S220.

In step S220, the CPU 20 determines whether the specific controller 90 to be updated is other than the driving system specific controllers 90. The contents of the process of step S220 are the same as the contents of the process of step S120. Therefore, the detailed contents of the process of step S220 are omitted. When the specific controller 90 to be updated is one of the driving system specific controllers 90 (NO in step S220), the CPU 20 advances the process to step S270.

In step S270, the CPU 20 provides a confirmation notification by voice. Specifically, the CPU 20 sends, to the speaker 73, an instruction signal for outputting a voice asking whether update is allowed. Then, the speaker 73 performs a voice guidance on asking whether update is allowed. The contents of the voice guidance include information that there is software to be updated and information asking whether to approve or refuse execution of the update process. When the voice guidance is performed, the CPU 20 advances the process to step S280.

In step S280, the CPU 20 determines whether the user has approved execution of the update process. Here, the voice recognition apparatus 72 is set as follows. When the voice recognition apparatus 72 collects the voice of the user, which means to approve execution of the update process, the voice recognition apparatus 72 sends, to the OTA master 10, a second approval signal indicating approval to execution of the update process. On the other hand, when the voice recognition apparatus 72 collects the voice of the user, which means to refuse execution of the update process, the voice recognition apparatus 72 sends, to the OTA master 10, a second refusal signal indicating refusal of execution of the update process. The second approval signal and the second refusal signal are predetermined as signals different from each other. When the CPU 20, in step S280, receives the second approval signal before a predetermined second standby time elapses from a point in time when the process proceeds to step S280, the CPU 20 determines that the user has approved execution of the update process (YES in step S280). In this case, the CPU 20 advances the process to step S240 at a point in time when the CPU 20 receives the second approval signal. The contents of the process of step S240 will be described later. The second standby time is, for example, the same as the first standby time.

On the other hand, when the CPU 20 does not receive the second approval signal before the second standby time elapses in step S280, the CPU 20 determines that the user has not approved execution of the update process (NO in step S280). In this case, the CPU 20 ends the second process. The determination of step S280 is negative in any one of the following cases. The first case is a case where neither the second approval signal nor the second refusal signal is received before the second standby time elapses from when the process proceeds to step S280. The second case is a case where the second refusal signal is received before the second standby time elapses from when the process proceeds to step S280. In the first case, the CPU 20 ends the second process at a point in time when the second standby time has elapsed. In the second case, the CPU 20 ends the second process at a point in time when the second refusal signal is received.

When the specific controller 90 to be updated is other than the driving system specific controllers 90 in step S220 (YES in step S220), the CPU 20 advances the process to step S230. In step S230, the CPU 20 determines whether a charging condition holds. The contents of the process of step S230 are basically the same as the contents of the process of step S130. However, the second requirement in the charging condition differs from that in step S130. The second requirement in step S230 is that the state of charge of the first battery 61 at a current point in time is lower than or equal to a second state of charge. The second state of charge is predetermined as a value slightly higher than the first state of charge. The reason why the second state of charge is set so as to be higher than the first state of charge is because of a relation to a configuration that the activation process in the update process is not executed in step S240 (described later). As for other than the second requirement, the contents of the process of step S230 are the same as those of step S130. Therefore, further description of step S230 is omitted.

When the charging condition does not hold in step S230 (NO in step S230), the CPU 20 advances the process to step S270. The determination of step S230 is negative in any one of the following situations. The first situation is a situation in which the travel speed of the vehicle 100 is higher than zero, that is, a situation in which the vehicle 100 is running. The second situation is a situation in which the travel speed of the vehicle 100 is zero, that is, a situation in which the vehicle 100 is stopped. Here, in consideration of the fact that the system of the vehicle 100 is on at an execution point in time of step S230, the second situation is a situation as follows. In other words, the second situation is a situation in which the vehicle 100 is stopped at a current point in time but the vehicle 100 is highly likely to start moving at a relatively early stage later. In any one of these first situation and second situation, the CPU 20 advances the process to step S270 already described and provides a confirmation notification. On the other hand, when the charging condition holds in step S230 (YES in step S230), the CPU 20 advances the process to step S240.

In step S240, the CPU 20 executes the download process and the installing process on the specific controller 90 to be updated. The contents of these processes are the same as described in the first process. Therefore, the description is omitted here. When the CPU 20 executes the download process and the installing process, the CPU 20 advances the process to step S250.

In step S250, the CPU 20 determines whether the system of the vehicle 100 has switched from the on state to the off state. When the system of the vehicle 100 is on (NO in step S250), the CPU 20 executes the process of step S250 again. In other words, the CPU 20 waits until the system of the vehicle 100 switches from the on state to the off state. When the system of the vehicle 100 switches from the on state to the off state (YES in step S250), the CPU 20 advances the process to step S260. When time to execute the next second process comes while the CPU 20 is repeating the process of step S250, the CPU 20 cancels execution of the next second process.

In step S260, the CPU 20 executes the activation process. The contents of the activation process are the same as those described in the first process. Therefore, the description is omitted here. When the CPU 20 completes the activation process, the CPU 20 ends the second process. Time to execute the first process may come in the middle of execution of step S260. In this case, the CPU 20 cancels execution of the first process at that time.

### Operation of Embodiment

### (A) First Process

The CPU 20 executes the update process in the following cases through the first process.

(A1) It is assumed that the update software received from the OTA server 500 is intended for other than the driving system specific controllers 90 (YES in step S120). At this time, it is assumed that the first battery 61 is not being charged (NO in step S130). Then, it is assumed that the permission period is already set (YES in step S150). In this case, when the date and time in the permission period comes (YES in step S155), the CPU 20 starts the update process (step S140). In other words, when the permission period is set on the precondition that the update software is other than the driving system specific controllers 90, the CPU 20 executes the update process not on condition that the first approval signal is acquired.

(A2) As in the case of (A1), it is assumed that the update software is intended for other than the driving system specific controllers 90 (YES in step S120) and the first battery 61 is not being charged (NO in step S130). At this time, it is assumed that no permission period is set (NO in step S150). In this case, the CPU 20 executes the update process when the user approves the update process in response to the confirmation notification in step S160 (step S140). In other words, when no permission period is set, the CPU 20 executes the update process on condition that the first approval signal is acquired.

(A3) It is assumed that the update software is intended for other than the driving system specific controllers 90 (YES in step S120). At this time, it is assumed that the first battery 61 is being charged (YES in step S130). In this case, the CPU 20 starts the update process (step S140). In other words, on the precondition that the update software is intended for other than the driving system specific controllers 90, while the first battery 61 is being charged, the CPU 20 executes the update process not on condition that the first approval signal is acquired regardless of whether the permission period is set.

(A4) It is assumed that the update software is intended for one of the driving system specific controllers 90 (NO in step S120). In this case, the CPU 20 executes the update process when the user approves the update process in response to the confirmation notification in step S160 regardless of whether the permission period is set (step S140). In other words, when the specific controller 90 to be updated is one of the driving system specific controllers 90, the CPU 20 executes the update process on condition that the first approval signal is acquired regardless of whether the permission period is set.

### (B) Second Process

The CPU 20 executes the update process in the following cases through the second process.

(B1) It is assumed that update software received from the OTA server 500 is intended for other than the driving system specific controllers 90 (YES in step S220). At this time, it is assumed that the first battery 61 is not being charged (NO in step S230). As described above, the determination of step S230 is negative in a situation in which the vehicle 100 is running or in a situation in which the vehicle 100 is highly likely to start moving. Under such a situation, when the user approves the update process in response to the confirmation notification in step S270, the CPU 20 executes the update process (step S240, step S260). In this way, in a situation in which the vehicle 100 is running or the vehicle 100 is highly likely to start moving, the CPU 20 executes the update process on condition that the second approval signal is acquired regardless of whether the permission period is set.

(B2) It is assumed that the update software is intended for other than the driving system specific controllers 90 (YES in step S220). At this time, it is assumed that the first battery 61 is being charged (YES in step S230). In this case, the CPU 20 starts the update process in step S240. In other words, on the precondition that the update software is intended for other than the driving system specific controllers 90, while the first battery 61 is being charged, the CPU 20 executes the update process not on condition that the second approval signal is acquired regardless of whether the permission period is set.

(B3) It is assumed that the update software is intended for one of the driving system specific controllers 90 (NO in step S220). In this case, the CPU 20 executes the update process when the user approves the update process in response to the confirmation notification in step S270 regardless of whether the permission period is set (step S240, step S260). In other words, when the specific controller 90 to be updated is one of the driving system specific controllers 90, the CPU 20 executes the update process on condition that the second approval signal is acquired regardless of whether the permission period is set.

### Advantageous Effects of Embodiment

(1) As described in (A1), in the first process, when the permission period is set in advance, the CPU 20 executes the update process in the permission period without obtaining approval of the user. Accordingly, the number of opportunities that the user gives approval can be reduced. Therefore, it is possible to reduce burden on the user in connection with approval to the update process. In addition, the update process is executed in the permission period set by the user, so the user him or herself is able to control the time to execute the update process. On the other hand, as described in (A2), in the first process, when no permission period is set in advance, the CPU 20 obtains approval of the user and then executes the update process. For example, in the case of (A2), when the user refuses approval to the update process in response to the confirmation notification in step S160 (NO in step S170), the CPU 20 suspends execution of the update process. With such a configuration, it is possible to reduce a situation in which the update process is thoughtlessly executed when the user does not want a software update. As a whole, with the configuration of the present embodiment, it is possible to improve user convenience in updating software.

(2) It is assumed that the driving system specific controllers 90 are updated before the user knows it. In this case, the user may experience an uncomfortable feeling because, while the vehicle 100 is running after the update, control over running different from before is executed. In terms of this point, as described in (A4) and (B3), in the first process and the second process, when the driving system specific controllers 90 are updated, approval of the user is obtained, and then the update process is executed. Thus, the user is less likely to experience an uncomfortable feeling during running after the update.

(3) It is assumed that, for example, the download process and the installing process are executed while the vehicle 100 is running. In this case, an influence can be exerted on other control accordingly, or a process can be executed in a mode different from a mode during normal times. For this reason, when the update process is executed while the vehicle 100 is running, the user needs to recognize that a process different from that during normal times is being executed. As described in (B1), in the second process, the CPU 20 obtains approval of the user and then executes the update process in a situation in which the vehicle 100 is running or the vehicle 100 is highly likely to start moving. Therefore, even when the update process is executed in these situations, the user is less likely to experience an uncomfortable feeling.

(4) As described in (3), in the second process, approval regarding execution of the update process while the vehicle 100 is running can be obtained from the user. At this time, it is necessary not to exert an influence on driving operation of the user in relation to coping with the approval. In the second process, the CPU 20 uses voice recognition to obtain approval to the update process. In the case of voice recognition, for example, different from the case where the user performs input operation to the display 71, the user does not need to release hands from a steering wheel to cope with approval. Therefore, even while the vehicle 100 is running, it is less likely to interfere with driving of the user. Therefore, with the above configuration, it is possible to minimize burden on the user to obtain approval while the vehicle 100 is running.

(5) A period during which the first battery 61 is being charged by using the external power supply 300 is a non-running period of the vehicle 100. Therefore, the update process is allowed to be executed in this period. As described in (A3) and (B2), in the first process and the second process, while the first battery 61 is being charged, the CPU 20 executes the update process not on condition that the approval signal is acquired unless the specific controller 90 to be updated is not one of the driving system specific controllers 90. Accordingly, the frequency that the user gives approval is reduced.

### Modifications

The above-described embodiment may be modified as follows. The embodiment and the following modifications may be implemented in combination with each other without any technical contradiction.

The time to execute the setting process is not limited to the example of the above-described embodiment. For example, the CPU 20 may execute the setting process at the time when the system of the vehicle 100 switches from the off state to the on state or at the time when the system of the vehicle 100 switches from the on state to the off state.

The contents of the setting process are not limited to the above-described embodiment. The setting process just needs to be configured to be capable of setting a permission period based on input from the user through the input device.

The contents of the setting image U are not limited to the example of the above-described embodiment. The setting image U just needs to have appropriate contents to guide or receive setting of the permission period.

A manner to guide or receive setting of the permission period is not limited to using the display 71. For example, the speaker 73 may be used to guide setting of the permission period. The voice recognition apparatus 72 may be used to receive setting of the permission period.

How to set the permission period is not limited to the hour. For example, the permission period may be set by the minute.

The time to execute the first process is not limited to the example of the above-described embodiment. For example, the first process may be executed every three hours or every six hours. The time to execute the first process may be determined as needed such that a software update does not stagnate. This also applies to the second process.

The contents of the first process and the second process are not limited to the example of the above-described embodiment. The first process and the second process just need to be configured such that the following two operations can be implemented by combination of both. The first operation is to, when no permission period is set, execute the update process on condition that the approval signal is acquired. The second operation is to, when the permission period is set, execute the update process in the permission period not on condition that the approval signal is acquired. If the above-described two operations can be implemented in any one of the first process and the second process, the other process may be removed.

Executing the update process in the permission period in a case where the permission period is set just needs to satisfy the following details. In other words, at least one of the download process, the installing process, and the activation process just needs to be executed in the permission period. More specifically, for example, as part of the download process, at least part of each process just needs to be executed in the permission period.

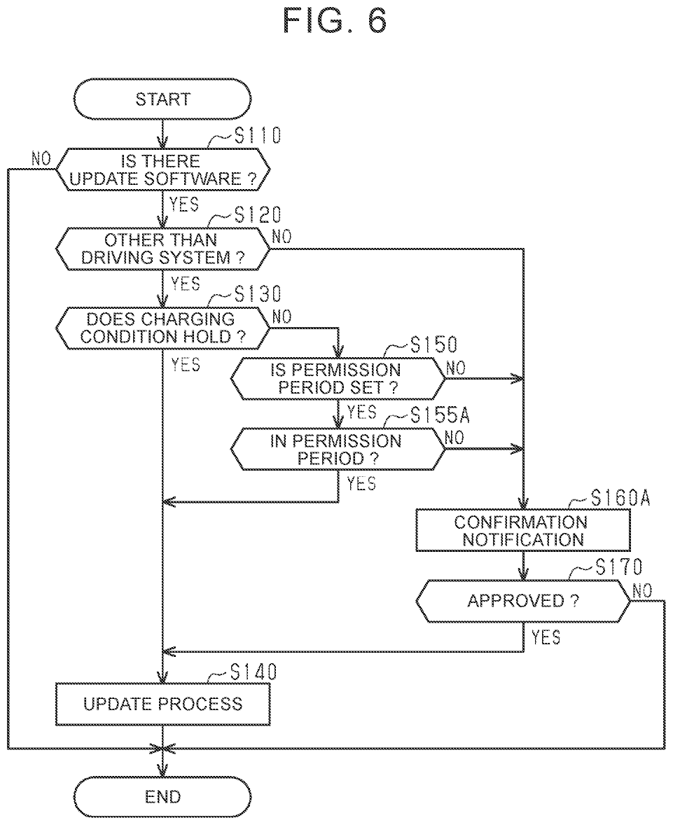

In step S155 of the first process of the above-described embodiment, step S155 does not need to be repeated when the date and time at the current point in time is outside the permission period. In the confirmation notification of step S160, a notification may be provided without waiting for the system of the vehicle 100 to enter the on state. In this case, for example, it is conceivable to change the contents of the first process as shown in FIG. 6. In the first process shown in FIG. 6, step S155A and step S160A are adopted instead of step S155 and step S160 shown in FIG. 4. In other words, when no permission period is set in step S150 (NO in step S150), the CPU 20 advances the process to step S160A. On the other hand, when the permission period is set (YES in step S150), the CPU 20 advances the process to step S155A. Then, in step S155A, the CPU 20 determines whether the date and time at that point in time is in the permission period. When the date and time at that point in time is outside the permission period in step S155A (NO in step S155A), the CPU 20 advances the process to step S160A. In step S160A, the CPU 20 sends, to an external apparatus via the communication module 14, an instruction signal for showing the approval image. The external apparatus that is a destination at this time is, for example, a smartphone carried by the user. After that, the CPU 20 executes the process of step S170. The process of step S170 is similar to that of the above-described embodiment except that the destination of the first approval signal is the external apparatus. In other words, the external apparatus is configured to be capable of sending the first approval signal to the OTA master 10 in response to input from the user. Then, the external apparatus is a component of the input device for receiving input from the user. In this way, an external input device not mounted on the vehicle 100 can be part of the software update system. In the case of this modification, even when no permission period is set or when the date and time at a current point in time is outside the permission period although the permission period is set, the CPU 20 updates software on condition that the approval signal is acquired. Even when no permission period is set or when the date and time at a current point in time is outside the permission period, there can be software with which an update needs to be early performed. The present modification is effective in performing a software update in such a case. Since software is allowed to be updated when no permission period is set or when the date and time at a current point in time is outside the permission period, the flexibility of the user to update software increases. Like step numbers to those of FIG. 4 are assigned to steps in which the same processes as those of FIG. 4 are executed in FIG. 6.

In relation to the modification shown in FIG. 6, the display 71 in the vehicle cabin may be used to provide a confirmation notification in step S160A.

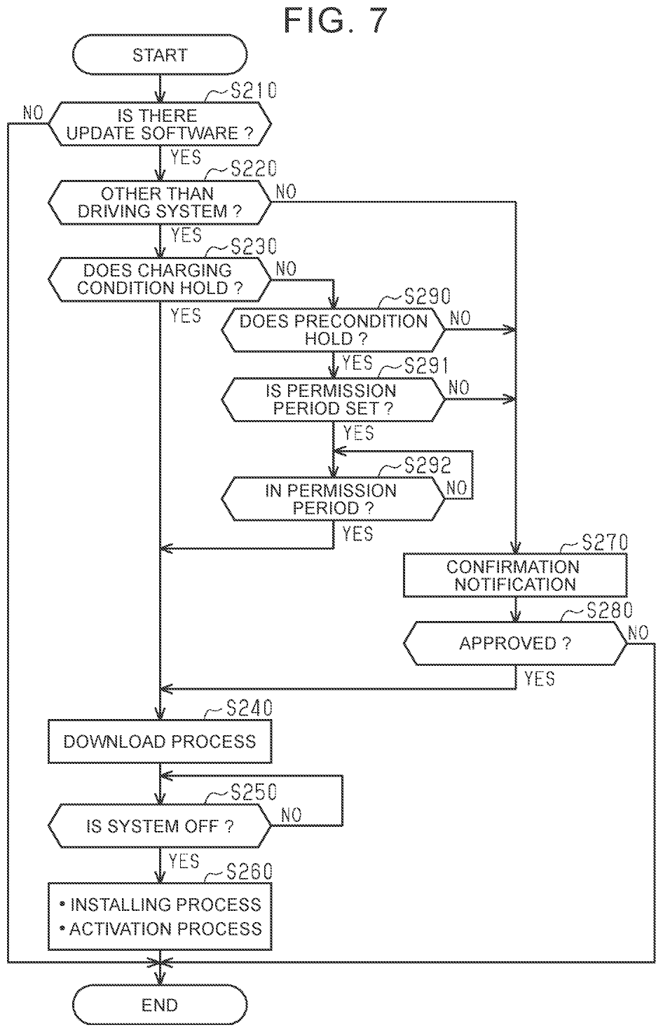

In the second process, whether the permission period is set may be considered to execute the update process. Furthermore, while the vehicle 100 is running or in a situation in which the vehicle 100 is highly likely to start moving, the update process may be executed not on condition that the approval signal is acquired. As a configuration taking these points into consideration, for example, the second process shown in FIG. 7 may be adopted. In the second process shown in FIG. 7, step S290, step S291, and step S292 are added to the second process shown in FIG. 5 as processes in a case where the determination is negative in step S230. Furthermore, in the second process shown in FIG. 7, the contents of the processes of step S240 and step S260 are partially changed from those in FIG. 5. In other words, when the charging condition does not hold in step S230 (NO in step S230), the CPU 20 advances the process to step S290. In step S290, the CPU 20 determines whether the predetermined precondition holds. The precondition is, for example, that the volume of update software is less than or equal to a predetermined volume. The predetermined volume is predetermined as a small volume properly to such an extent that the download process and the like can be quickly completed. In step S290, the CPU 20 determines whether the precondition holds based on the software information acquired in step S210. When the precondition does not hold (NO in step S290), the CPU 20 advances the process to step S270. In this case, the CPU 20, as in the case of the above-described embodiment, obtains approval of the user at that point in time in step S270 and step S280 and then executes the update process. On the other hand, when the precondition holds (YES in step S290), the CPU 20 advances the process to step S291. In step S291, the CPU 20 determines whether the permission period is set. Then, when no permission period is set, the CPU 20 advances the process to step S270. In this case as well, the CPU 20 obtains approval of the user at that point in time and then executes the update process. On the other hand, when the permission period is set in step S291 (YES in step S291), the CPU 20 advances the process to step S292. Then, in step S292, the CPU 20 determines whether the date and time at that point in time is in the permission period. When the date and time at that point in time is outside the permission period (NO in step S292), the CPU 20 executes the process of step S292 again. On the other hand, when the date and time at that point in time is in the permission period (YES in step S292), the CPU 20 advances the process to step S240. Then, the CPU 20 executes the download process in step S240. After that, the CPU 20 executes the process of step S250 and then executes the installing process and the activation process in step S260. When the system of the vehicle 100 switches from the on state to the off state while the CPU 20 is repeating the process of step S292, the CPU 20 may end the second process at that point in time. In the case of this modification, when the permission period comes while the vehicle 100 is running or just before the vehicle 100 starts moving (YES in step S292), the CPU 20 is allowed to execute the update process without obtaining approval of the user at that point in time. When, for example, the volume of the update software is small and the download process and the like can be quickly completed, a period of time to execute control different from that during normal times resulting from the download process is extremely a short period of time. In this case, the user is difficult to experience an uncomfortable feeling. Therefore, it is allowed to execute the update process without approval of the user while the vehicle 100 is running. As described in the above example, it is not indispensable to acquire an approval signal to update software while the vehicle 100 is running. Like step numbers to those of FIG. 5 are assigned to steps in which the same processes as those of FIG. 5 are executed in FIG. 7.

Not only the requirement of the above-described modification but also requirement that the travel speed of the vehicle 100 is zero may be added to the precondition. In this case, when the determination of step S292 is negative, the CPU 20 ends the second process at that point in time. When such a configuration is adopted, on the precondition that the volume of the update software is small, only when the vehicle 100 is stopped (YES in step S290), and when a point in time is in the permission period, the CPU 20 executes the download process without obtaining approval of the user at that point in time. On the other hand, when the travel speed of the vehicle 100 is higher than zero, the CPU 20 executes the download process on condition that the second approval signal is acquired in step S280 regardless of whether the permission period is set, as in the case of the above-described embodiment. To determine whether the travel speed of the vehicle 100 is zero, the detection result of the vehicle speed sensor 83 just needs to be read.

In relation to the second process shown in FIG. 7, when the determination of step S292 is negative, the process may be advanced to step S270. In other words, in a case where the permission period is set, even outside the permission period, the update process may be executed on condition that the second approval signal is acquired through step S270 and step S280.

As described with reference to FIG. 7, the contents of the update process, executed in step S240 and step S260 of the second process, may be changed from FIG. 5. Furthermore, the contents of the processes executed in step S240 and step S260 may be changed according to circumstances. For example, when the charging condition holds (YES in step S230), the CPU 20 executes the download process and the installing process in step S240 and executes the activation process in step S260. On the other hand, when approval of the user is obtained at that point in time (YES in step S280), the CPU 20 executes the download process in step S240 and executes the installing process and the activation process in step S260. Such a mode may be adopted.

In relation to the update process executed in step S260, the following mode may be adopted. In other words, the update process is not executed at a point in time when the system of the vehicle 100 switches from the on state to the off state. The update process may be executed after the system of the vehicle 100 switches from the on state to the off state and at a point in time when a predetermined third standby time has elapsed. In this case, execution of the first process just needs to be cancelled before, after the system of the vehicle 100 switches from the on state to the off state, the third standby time elapses and furthermore the update process is completed. This modification providing the third standby time is applicable to the activation process in a case where, in the first process of FIG. 4, the process proceeds from step S170 to step S140.

In a specific campaign, a plurality of the specific controllers 90 can be targets to be updated. Then, accordingly, a plurality of pieces of update software can be distributed from the OTA server 500 at a time for one vehicle 100. In this case, for example, in step S110 of the first process of FIG. 4, the CPU 20 receives, from the OTA server 500, software information of each of the specific controllers 90 to be updated. In this case, the CPU 20 may execute the processes in S120 and the following steps for each of the intended specific controllers 90 in parallel. In this case, in relation to the update process, depending on a communication situation or the like with the OTA server 500, the download process can be on a waiting list; however, there is no problem in executing a series of the processes in the update process. Here, the first process is taken as an example; however, the same applies to the second process.

In relation to whether approval is required according to the type of the specific controller 90, for example, for the specific controller 90, such as the HMI apparatus 70, configured to control an in-vehicle apparatus for exchanging information with the user in the vehicle cabin, the following mode may be adopted. In other words, regardless of whether the permission period is set and furthermore regardless of whether the first battery 61 is being charged, the update process may be executed not on condition that the approval signal is acquired. Even for the driving system specific controllers 90, depending on the contents or the like of an update, for example, in the permission period or during charging of the first battery 61, the update may be performed not on condition that the approval signal is acquired. Furthermore, in relation to the driving system specific controllers 90, when, for example, an update is needed in an emergency, or the like, the update may be performed not on condition that the approval signal is acquired regardless of the permission period or the charging situation. When an update of the driving system specific controller 90 is performed without obtaining approval of the user, a notification that the update intended for the driving system specific controller 90 is performed just needs to be provided to the user later. Thus, the user is less likely to experience an uncomfortable feeling after the update. In other words, the condition that the approval signal is acquired is not indispensable in updating the driving system specific controller 90. When the contents of an update like, for example, in an emergency, is incorporated into software information sent from the OTA server 500 to the OTA master 10, such a mode is possible.

Depending on the type of the specific controller 90 to be updated, when the system of the vehicle 100 is on, all the download process, installing process, and activation process can be executed. In such a case, all of them may be executed when the system of the vehicle 100 is on.

A mode of the confirmation notification in the first process and a mode of the confirmation notification in the second process are not limited to the example of the above-described embodiment. For example, in response to step S160 of the first process, a confirmation notification by way of voice guidance of the speaker 73 may be provided instead of or in addition to the confirmation notification by way of the display 71. Similarly, in step S270 of the second process, a confirmation notification using the display 71 may be provided instead of or in addition to the confirmation notification by way of voice guidance of the speaker 73.

In relation to step S270 of the second process, the confirmation notification of step S270 may be provided on condition that the vehicle 100 is stopped.

A mode to receive approval of the user for a confirmation notification is not limited to the example of the above-described embodiment. For example, as in the case of the above-described modification, when a confirmation notification is provided by using the display 71 in step S270 of the second process, the first approval signal from the display 71 may be received in step S280. In step S280, both the first approval signal from the display 71 and the second approval signal from the voice recognition apparatus 72 may be received. Furthermore, the approval signal may be received by using a device other than the display 71 or the voice recognition apparatus 72. For example, the push switch 74 may be used as an input device that receives input from the user. In this case, the approval signal indicating approval of execution of the update process may be allowed to be sent from the push switch 74 to the OTA master 10. When the push switch 74 is used as the input device, the push switch 74 is preferably provided on the steering wheel from the viewpoint that it is less likely to interfere with driving operation of the user. When the push switch 74 is provided on the steering wheel, a similar advantageous effect to the above (4) is obtained. In step S170 of the first process as well, an apparatus that is a source of the approval signal may be changed as needed.

Another apparatus may be adopted as the HMI apparatus 70 of the vehicle 100 instead of or in addition to those of the above-described embodiment. For example, a display provided at a meter panel may be adopted instead of or in addition to a center display of the above-described embodiment. The display is called front display. The confirmation notification may be provided by using the front display. For example, to obtain approval of the user in step S170 or step S280, the contents of response of the user, obtained via the voice recognition apparatus 72 or the push switch 74 of the steering wheel, may be displayed on the front display.

The charging condition in the first process and the charging condition in the second process are not limited to the example of the above-described embodiment. For example, the second requirement may be removed. The charging condition just needs to include requirement that the first battery 61 is being charged.

A technique to determine whether the first battery 61 is being charged is not limited to the example of the above-described embodiment. Not limited to the one using the charge sensor 82 as in the case of the above-described embodiment, any technique may be applied as long as the technique is capable of appropriately determining whether the first battery 61 is being charged.

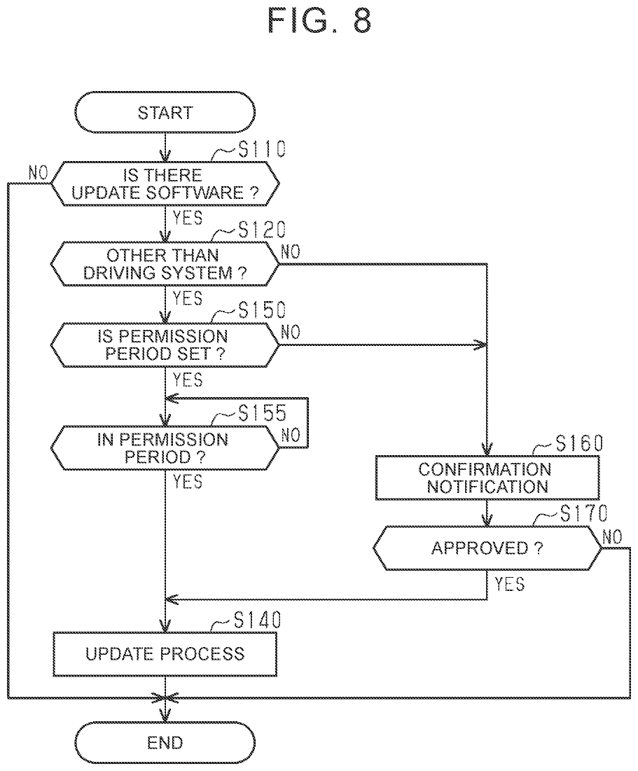

In the first process and the second process, it is not indispensable to consider whether approval is required according to whether the first battery 61 is being charged. When determination as to charge of the first battery 61 in the first process is removed, for example, the first process shown in FIG. 8 may be adopted. In other words, when the CPU 20 determines in step S120 that the specific controller 90 to be updated is other than the driving system specific controllers 90, the CPU 20 may advance the process to step S150. Like step numbers to those of FIG. 4 are assigned to steps in which the same processes as those of FIG. 4 are executed in FIG. 8.

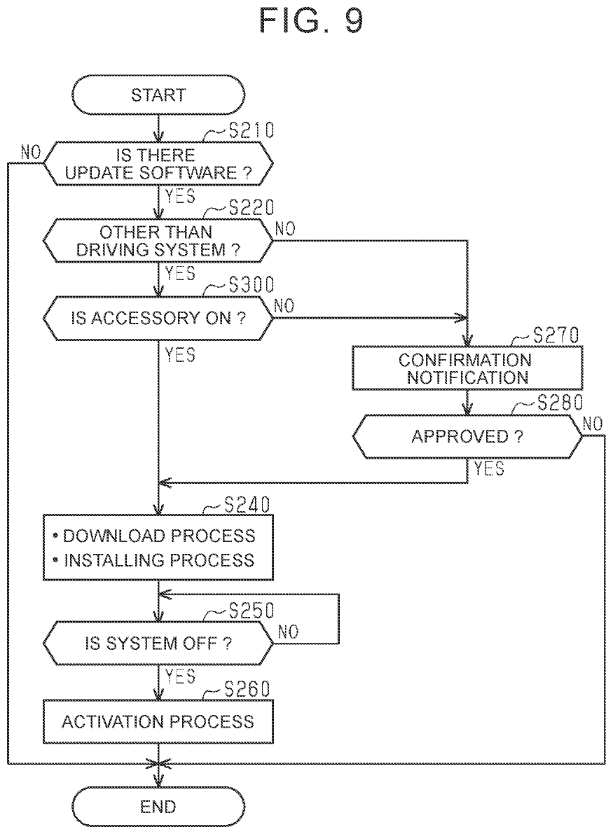

When determination as to charge of the first battery 61 in the second process is removed, for example, the second process shown in FIG. 9 may be adopted. In the second process shown in FIG. 9, the process of step S300 is adopted instead of determining in step S230 whether the first battery 61 is being charged. In step S300, the CPU 20 determines whether the vehicle 100 is in the accessory on state. Then, when the vehicle 100 is in the accessory on state (YES in step S300), the CPU 20 advances the process to step S240. On the other hand, when the vehicle 100 is not in the accessory on state (NO in step S300), the CPU 20 advances the process to step S270. Like step numbers to those of FIG. 5 are assigned to steps in which the same processes as those of FIG. 5 are executed in FIG. 9.

The length of standby time used in various processes, such as the predetermined period of time used in the setting process and the first standby time used in the first process, may be set as needed according to their uses.

A single-bank structure may be adopted to a nonvolatile memory of the specific controller 90. In the memory of this type, different from a double-bank structure, only one storage area is present. When data is being read from the memory, data cannot be written into the memory. For this reason, when a nonvolatile memory with a single-bank structure is adopted, it is conceivable that, basically, not only the activation process but also the installing process is executed when the system of the vehicle 100 is off.

A nonvolatile memory with a double-bank structure may be adopted for each of one or some of the specific controllers 90, and a nonvolatile memory with a single-bank structure may be adopted to the remainder of the specific controllers 90. The installing process and the activation process may be executed at appropriate timing according to the structure of the nonvolatile memory of the specific controller 90 to be updated.

In the same specific controller 90, nonvolatile memories with different structures may be respectively adopted to a first memory and a second memory.

In the same specific controller 90, one nonvolatile memory may be used as the first memory and the second memory.

The above-described modification related to a nonvolatile memory is also applicable to the OTA master 10. In other words, a nonvolatile memory with a single-bank structure may be adopted as the nonvolatile memory of the OTA master 10. Nonvolatile memories with different structures may be respectively adopted to the first memory 21 and the second memory 22. A single nonvolatile memory may double as the first memory 21 and the second memory 22.

The OTA master 10 may update its own software. In other words, an electronic control unit for which the OTA master 10 intends to update software can be the OTA master 10 itself.

The overall configuration of the vehicle 100 is not limited to the example of the embodiment. For example, the vehicle 100 may include an engine in addition to the motor apparatus 51 as a driving source of the vehicle 100. In other words, the vehicle 100 may be a plug-in hybrid electric vehicle. For example, the connector 68 may be removed from the vehicle 100. In other words, the vehicle 100 may be a hybrid electric vehicle not allowed to be charged from the external power supply 300. Alternatively, for example, the vehicle 100 may be an engine vehicle that does not include the motor apparatus 51 as a driving source of the vehicle 100.

When the vehicle 100 that is neither a battery electric vehicle nor a plug-in hybrid electric vehicle is adopted, the first process shown in FIG. 8 and the second process shown in FIG. 9 may be applied to the vehicle 100. Then, at this time, the configuration of each of the modifications may be applied as needed. For example, a configuration to determine whether approval is required according to the type of the specific controller 90 to be updated may be applied. For example as described with reference to FIG. 7, a configuration to consider whether there is a permission period when the system of the vehicle 100 is on may be applied. Alternatively, for example, as described with reference to FIG. 6, a configuration to execute the update process by obtaining approval outside the permission period in a case where the permission period is set may be applied.

The OTA master 10 may include a processing circuit including one or more processors that execute various processes in accordance with a computer program (software). The OTA master 10 may include a processing circuit including one or more dedicated hardware circuits, such as application specific integrated circuits (ASICs), that execute at least one or some of the various processes or a processing circuit including a combination of the processor and a dedicated hardware circuit. The processor includes a CPU and a memory, such as a RAM and a ROM. The memory stores a program code or an instruction configured to cause the CPU to execute a process. The memory, that is, a computer-readable medium, includes any usable medium accessible by a general-purpose or special-purpose computer. The present modification is also applicable to the specific controller 90.

The above-described embodiment and modifications include components described below.

A software update system according to an aspect of the present disclosure is a system for a vehicle. The software update system includes: an electronic control unit mounted on the vehicle; an information processing apparatus configured to manage an update of software of the electronic control unit; and an input device configured to receive input from a user. The information processing apparatus is configured to set a permission period of an update process based on input through the input device, the update process being a process in which software of the electronic control unit is updated to update software, when no permission period is set, execute the update process on condition that an approval signal indicating approval to the update process is acquired from the input device, and when the permission period is set, execute the update process in the permission period not on the condition that the approval signal is acquired.

In the above aspect, the information processing apparatus may be further configured to, when the permission period is set, execute the update process outside the permission period on the condition that the approval signal is acquired.

In the above aspect, the information processing apparatus may be configured to, when the electronic control unit of which the software is to be updated is configured to control a driving source of the vehicle or a brake device of the vehicle, execute the update process on the condition that the approval signal is acquired regardless of whether the permission period is set.

In the above aspect, the software update system may further include a vehicle speed sensor configured to detect a travel speed of the vehicle. The information processing apparatus is configured to, when the travel speed of the vehicle, acquired by the vehicle speed sensor, is higher than zero, execute the update process on the condition that the approval signal is acquired regardless of whether the permission period is set.

In the above aspect, the input device may be a voice recognition apparatus provided in a cabin of the vehicle or a push switch provided on a steering wheel of the vehicle.

In the above aspect, the software update system may further include a battery rechargeable from a power supply outside the vehicle, wherein the information processing apparatus is further configured to, when the battery is being charged, execute the update process not on the condition that the approval signal is acquired regardless of whether the permission period is set.

What is claimed is:

1. An information processing apparatus for a vehicle, the information processing apparatus comprising one or more processors configured to:
set a permission period of an update process based on input from an outside, the update process being a process in which software of an electronic control unit mounted on the vehicle is updated to update software;
when no permission period is set, execute the update process on condition that an approval signal indicating approval to the update process is acquired; and
when the permission period is set, execute the update process in the permission period not on the condition that the approval signal is acquired.

2. A software update system for a vehicle, the software update system comprising:
an electronic control unit mounted on the vehicle;
an information processing apparatus configured to manage an update of software of the electronic control unit; and
an input device configured to receive input from a user, wherein
the information processing apparatus is configured to
set a permission period of an update process based on input through the input device, the update process being a process in which software of the electronic control unit is updated to update software,
when no permission period is set, execute the update process on condition that an approval signal indicating approval to the update process is acquired from the input device, and
when the permission period is set, execute the update process in the permission period not on the condition that the approval signal is acquired.

3. The software update system according to claim 2, wherein the information processing apparatus is further configured to, when the permission period is set, execute the update process outside the permission period on the condition that the approval signal is acquired.

4. The software update system according to claim 2, wherein the information processing apparatus is configured to, when the electronic control unit of which the software is to be updated is configured to control a driving source of the vehicle or a brake device of the vehicle, execute the update process on the condition that the approval signal is acquired regardless of whether the permission period is set.

5. The software update system according to claim 2, further comprising a vehicle speed sensor configured to detect a travel speed of the vehicle, wherein the information processing apparatus is configured to, when the travel speed of the vehicle, acquired by the vehicle speed sensor, is higher than zero, execute the update process on the condition that the approval signal is acquired regardless of whether the permission period is set.

6. The software update system according to claim 5, wherein the input device is a voice recognition apparatus provided in a cabin of the vehicle or a push switch provided on a steering wheel of the vehicle.

7. The software update system according to claim 2, further comprising a battery rechargeable from a power supply outside the vehicle, wherein the information processing apparatus is further configured to, when the battery is being charged, execute the update process not on the condition that the approval signal is acquired regardless of whether the permission period is set.

8. A non-transitory storage medium storing instructions executable on an information processing apparatus and causing the information processing apparatus to execute functions, the information processing apparatus being mounted on a vehicle together with an electronic control unit, the information processing apparatus being configured to manage software of the electronic control unit, the functions comprising:
setting a permission period of an update process based on input from an outside, the update process being a process in which the software of the electronic control unit is updated to update software;
when no permission period is set, executing the update process on condition that an approval signal indicating approval to the update process is acquired; and
when the permission period is set, executing the update process in the permission period not on the condition that the approval signal is acquired.
